(19) United States
(12) Patent Application Publication
(10) Pub. No.: US 2021/0022956 A1
(43) Pub. Date: Jan. 28, 2021

(54) METHOD OF TREATING THE LOWER SPINE TO REDUCE OR ELIMINATE REFERRED OR NON-SPECIFIC PAIN (GHOST PAIN) IN THE PELVIS AND ABDOMEN INCLUDING THE BLADDER, PROSTATE, TESTICLES, GENITALIA AND DIGESTIVE TRACT

(71) Applicant: Tissue Regeneration Technologies, LLC, Woodstock, GA (US)

(72) Inventor: John F. Warlick, Woodstock, GA (US)

(21) Appl. No.: 16/935,361

(22) Filed: Jul. 22, 2020

Related U.S. Application Data
(60) Provisional application No. 62/878,455, filed on Jul. 25, 2019.

(51) Int. Cl. A61H 23/00

(52) U.S. Cl. CPC A61H 23/008; A61H 2201/0153; A61H 2205/087; A61H 2205/083; A61H 2201/1654

(57) ABSTRACT

A method of treating a patient exhibiting abdominal or pelvic pain by applying shockwaves or acoustic pulses to the lower spine, lumbar and sacral spine, to modulate, reduce or relieve spinal stenosis, inflammation, injury or disease and has the steps of: activating an acoustic shock wave or acoustic wave generator or source to emit acoustic shock waves or pulses from a fixed acoustic wave source or a handheld shock wave head or from electrodes embedded within a catheter with or without a fluid filled balloon catheter; and administering a plurality of acoustic shock or acoustic waves in a pulse or wave pattern within the targeted tissue of less than 10.0 mJ/mm² per shock wave, the plurality of acoustic shock or acoustic waves in a pulse or wave pattern should be directed to a portion of a lower spine exhibiting chronic pain and/or inflammation.

### TECHNICAL FIELD

The present invention relates to a treatment for chronic pain and inflammation using acoustic shock waves.

### BACKGROUND OF THE INVENTION

Many people suffer from chronic back pain. Aging and trauma are commonly associated with these conditions. Chronic pain associated with these conditions has led to a rise in addictive pain medication usage. This sadly is at an epidemic proportion causing many deaths.

The condition of spinal stenosis causes a narrowing of the spine putting pressure on the nerves causing inflammation and chronic pain. A little known or unappreciated consequence of back pain is the creation of ghost pain. Ghost pain is a non-specific pain that can emanate from all over the body near or even far removed from the lower spine. These ghost pain conditions are linked to the radiating inflammation from the lower spine.

The present invention described below provides an effective treatment for the lower spine and the associated ghost pain.

### SUMMARY OF THE INVENTION

A method of treating a patient exhibiting abdominal or pelvic pain by applying shockwaves or acoustic pulses to the lower spine, lumbar and sacral spine, to modulate, reduce or relieve spinal stenosis, inflammation, injury or disease and has the steps of: activating an acoustic shock wave or acoustic wave generator or source to emit acoustic shock waves or pulses from a fixed acoustic wave source or a handheld shock wave head or from electrodes embedded within a catheter with or without a fluid filled balloon catheter; and administering a plurality of acoustic shock or acoustic waves in a pulse or wave pattern within the targeted tissue of less than 10.0 mJ/mm² per shock wave, the plurality of acoustic shock or acoustic waves in a pulse or wave pattern should be directed to a portion of a lower spine exhibiting chronic pain and/or inflammation.

The chronic pain and inflammation radiating from the lower spine region to other organs or connective tissue causes acute or chronic pain in the organs or connective tissue of the abdomen, pelvis, or genitalia. The step of administering a plurality of acoustic or shock waves to the lower spine reduces chronic pain and inflammation radiating at the lower spine and further reduces chronic pain including orchialgia, prostatitis, bladder pain, interstitial cystitis or digestive tract pain.

The chronic pain and inflammation at the lower spine region radiates causing ghost or referred pain defined as non-specific pain at other organs or connective tissue and/or parts of the body and the method further includes the step of reducing ghost pain by administering the plurality of acoustic shock waves to the lower spine and locations at or near the areas exhibiting the ghost pain. In addition, the method includes treating Persistent Gonad Arousal Disorder, PGAD.

### Definitions

A “curved emitter” is an emitter having a curved reflecting (or focusing) or emitting surface and includes, but is not limited to, emitters having ellipsoidal, parabolic, quasi parabolic (general paraboloid) or spherical reflector/reflecting or emitting elements. Curved emitters having a curved reflecting or focusing element generally produce waves having focused wave fronts, while curved emitters having a curved emitting surfaces generally produce wave having divergent wave fronts.

“Divergent waves” in the context of the present invention are all waves which are not focused and are not plane or nearly plane. Divergent waves also include waves which only seem to have a focus or source from which the waves are transmitted. The wave fronts of divergent waves have divergent characteristics. Divergent waves can be created in many different ways, for example: A focused wave will become divergent once it has passed through the focal point. Spherical waves are also included in this definition of divergent waves and have wave fronts with divergent characteristics.

“Extracorporeal” occurring or based outside the living body.

“Inflammation” a local response to cellular injury that includes one or more of capillary dilatation, leukocytic infiltration, redness, heat, pain, swelling, and often loss of function.

“Orchialgia” chronic testicular pain.

“Plane waves” are sometimes also called flat or even waves. Their wave fronts have plane characteristics (also called even or parallel characteristics). The amplitude in a wave front is constant and the “curvature” is flat (that is why these waves are sometimes called flat waves). Plane waves do not have a focus to which their fronts move (focused) or from which the fronts are emitted (divergent). “Nearly plane waves” also do not have a focus to which their fronts move (focused) or from which the fronts are emitted (divergent). The amplitude of their wave fronts (having “nearly plane” characteristics) is approximating the constancy of plain waves. “Nearly plane” waves can be emitted by generators having pressure pulse/shock wave generating elements with flat emitters or curved emitters. Curved emitters may comprise a generalized paraboloid that allows waves having nearly plane characteristics to be emitted.

A “pressure pulse” according to the present invention is an acoustic pulse which includes several cycles of positive and negative pressure. The amplitude of the positive part of such a cycle should be above about 0.1 MPa and its time duration is from below a microsecond to about a second. Rise times of the positive part of the first pressure cycle may be in the range of nano-seconds (ns) up to some milli-seconds (ms). Very fast pressure pulses are called shock waves. Shock waves used in medical applications do have amplitudes above 0.1 MPa and rise times of the amplitude can be below 1000 ns, preferably at or below 100 ns. The duration of a shock wave is typically below 1-3 micro-seconds (μs) for the positive part of a cycle and typically above some micro-seconds for the negative part of a cycle.

“Prostatitis” chronic prostate pain. Prostatitis [chronic prostatitis/chronic pelvic pain syndrome (CP/CPPS)] is a common condition in men that accounts for a significant number of visits to a medical doctor or urologist. It is one of the most widely diagnosed conditions in men attending urologic clinics.

“Shock Wave”: As used herein is defined by Camilo Perez, Hong Chen, and Thomas J. Matula; Center for Industrial and Medical Ultrasound, Applied Physics Laboratory, University of Washington, 1013 NE 40th Street, Seattle, Wash. 98105; Maria Karzova and Vera A. Khokhlovab; Department of Acoustics, Faculty of Physics, Moscow State University, Moscow 119991, Russia; (Received 9 Oct. 2012; revised 16 Apr. 2013; accepted 1 May 2013) in their publication, “Acoustic field characterization of the Duolith: Measurements and modeling of a clinical shock wave therapy device”; incorporated by reference herein in its entirety.

Spinal stenosis is a narrowing of the spaces within the spine, which can put pressure on the nerves that travel through the spine. Spinal stenosis occurs most often in the lower back and the neck.

Waves/wave fronts described as being “focused” or “having focusing characteristics” means in the context of the present invention that the respective waves or wave fronts are traveling and increase their amplitude in direction of the focal point. Per definition the energy of the wave will be at a maximum in the focal point or, if there is a focal shift in this point, the energy is at a maximum near the geometrical focal point. Both the maximum energy and the maximal pressure amplitude may be used to define the focal point.

### BRIEF DESCRIPTION OF THE DRAWINGS

The invention will be described by way of example and with reference to the accompanying drawings in which:

FIG. 1 is a simplified depiction of a pressure pulse/shock wave (PP/SW) generator with focusing wave characteristics.

FIG. 2 is a simplified depiction of a pressure pulse/shock wave generator with plane wave characteristics.

FIG. 3 is a simplified depiction of a pressure pulse/shock wave generator with divergent wave characteristics.

FIG. 4 is a simplified depiction of a pressure pulse/shock wave generator being connected to a control/power supply unit.

FIG. 5 shows an exemplary shock wave generator device.

FIG. 6 shows a patient being treated extracorporeally with shock waves being transmitted through the skin and spinal bone tissue to the neurological region to be treated.

FIG. 7 shows a diagram from Gray's Anatomy showing the various organs, glands and tissues that are connected by the nerves and controlled by the regions of the medulla oblongata to the end of the spinal cord.

### DETAILED DESCRIPTION OF THE INVENTION

All chronic pain can be effectively treated with shockwaves by treating the lower spine exhibiting stenosis, inflammation, injury or disease. Obviously, much pain can be attributed to other things, such as a site specific injury; however, by way of example most abdominal chronic pain starts from the spine. This is caused by radiating inflammation, the same as if you injure your shoulder and keep utilizing it until eventually your whole upper arm and neck hurts.

After a spine injury or insult, people continue to stress the injury and radiating pain can spread anywhere in abdomen, pelvic and groin areas. Most “ghost” “nonspecific pain” can be cured by treating spine alone, or the painful area and spine in combination.

The goal in such treatments is to provide 100 to 3000 acoustic shock waves or pressure pulses at a voltage of 14 kV to 28 kV across a spark gap generator in a single treatment preferably or one or more adjuvant treatments by impinging the emitted waves on the lower spine.

The unfocused shock waves can be of a divergent wave pattern or near planar pattern preferably of a low peak pressure amplitude and density. Typically, the energy density values range as low as 0.000001 mJ/mm² and having a high-end energy density of below 1.0 mJ/mm², preferably 0.40 mJ/mm² or less, more preferably 0.20 mJ/mm2 or less. The peak pressure amplitude of the positive part of the cycle should be above 1.0 and its duration is below 1-3 microseconds.

The treatment depth can vary from the surface to the full depth of the human or animal torso and the treatment site can be defined by a much larger treatment area than the 0.10-3.0 cm² commonly produced by focused waves. The above methodology is particularly well suited for surface as well as sub-surface soft tissue treatments in the lower spine and the affected areas.

An exemplary treatment protocol could have emitted shock waves in a broad range of 0.01 mJ/mm² to 3.0 mJ/mm² and 200-2500 pulses per treatment with a treatment schedule of 1-3 weekly treatments until symptoms reduce. This can be repeated as symptoms reoccur or continue weekly as a preventative. The post medical treatment is beneficial as a pain suppressor and reduces the need for pain medications and allows less addictive medications to be used to prevent addiction.

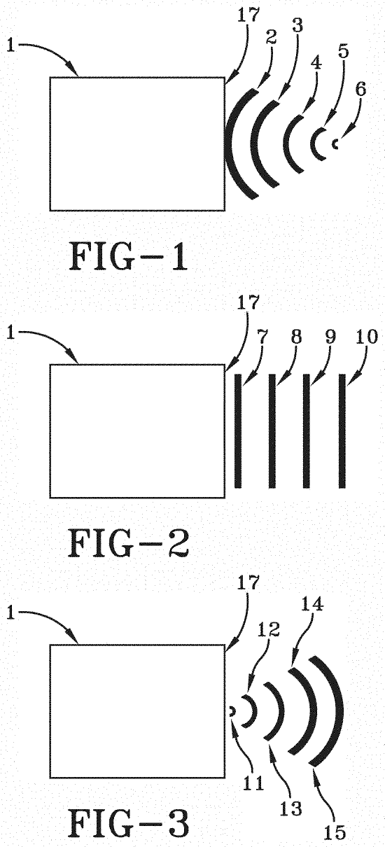

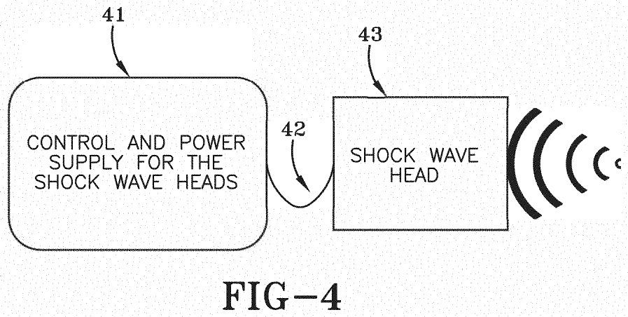

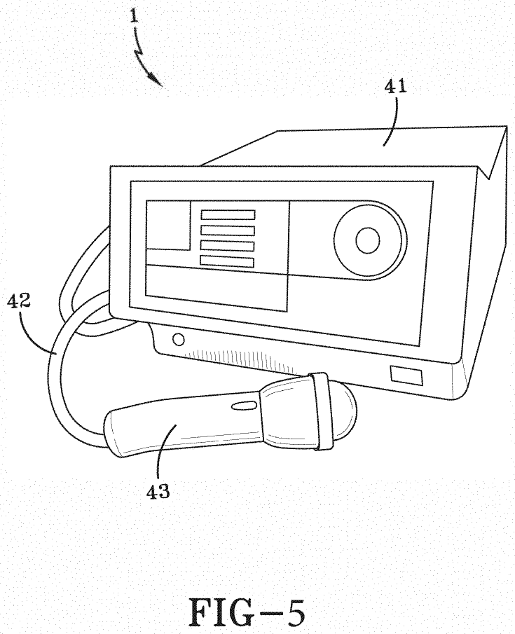

The following invention description first provides a detailed explanation of acoustic shock waves or pressure pulses, as illustrated in FIGS. 1-6. As used herein an acoustic shock wave is an asymmetric wave with an exceptionally rapid peak rise time and slower return time from the peak amplitude. Historically, these acoustic shock waves or pressure pulses were first used medically to destroy kidney stones. The wave patterns were directed to a focal point with ah a relatively high energy to blast the concrements into small urinary tract passable fragments.

A whole class of acoustic shock waves or pressure pulses for medical treatments were later discovered that employed low energy acoustic shock waves or pressure pulses. These low energy acoustic shock waves or pressure pulses maintained the asymmetric wave profile, but at much lower energies as described in US2006/0100550 which is incorporated herein in its entirety.

These low energy acoustic shock waves or pressure pulses advantageously could stimulate a substance without requiring a focused beam. The advantage of such an unfocused beam was the acoustic wave could be directed to pass through tissue without causing any cell rupturing which would be evidenced by a lack of a hematoma or bruising. This use of unfocused, low energy acoustic shock waves or pressure pulses provided an ability to treat a large volume of tissue virtually painlessly. Furthermore, the acoustic energy caused a short duration anesthetic sensation that effectively numbs the patient's pain over a period of days with a prolonged reduction in pain thereafter.

The use of low energy acoustic shock waves or pressure pulses that employ a focused beam has been spurred on as a viable alternative to the unfocused low energy shock waves because the focal point being of a small point of energy has little or a small region of cell damage as the remaining portions of the wave pattern can provide a stimulating effect similar to the unfocused shock waves. Basically, the effect is the same with the users of focused waves achieving the benefits of the unfocused waves, but with a focal point of peak energy in a tiny localised region. So, for purposes of the present invention, the use of “soft waves” those defined by low energy beams will be applicable to both focused and unfocused beams o acoustic shock waves or pressure pulses for the present invention.

One last and significant point that the reader must appreciate is that an “acoustic shock wave” is not an “ultrasound wave”. Sonic or ultrasound waves are generated with a uniform and symmetrical wave pattern similar to a sinusoidal wave. This type of sonic wave causes a sheer action on tissue as evidenced by a generation of heat within the tissue, for this reason, the use of sonic waves of the ultrasonic type are not considered as efficient in cell survivability rates. The present invention provides an apparatus for an effective treatment of indications, which benefit from high or low energy pressure pulse/shock waves having focused or unfocused, nearly plane, convergent or even divergent characteristics. With an unfocused wave having nearly plane, plane, convergent wave characteristic or even divergent wave characteristics, the energy density of the wave may be or may be adjusted to be so low that side effects including pain are very minor or even do not exist at all.

In certain embodiments, the apparatus of the present invention is able to produce waves having energy density values that are below 0.1 mJ/mm² or even as low as 0.000 001 mJ/mm². In a preferred embodiment, those low-end values range between 0.1-0.001 mJ/mm². With these low energy densities, side effects are reduced, and the dose application is much more uniform. Additionally, the possibility of harming surface tissue is reduced when using an apparatus of the present invention that generates unfocused waves having planar, nearly plane, convergent or divergent characteristics and larger transmission areas compared to apparatuses using a focused shock wave source that need to be moved around to cover the affected area. The apparatus of the present invention also may allow the user to make more precise energy density adjustments than an apparatus generating only focused shock waves, which is generally limited in terms of lowering the energy output. Nevertheless, in some cases the first use of a high energy focused shock wave targeting a treatment zone may be the best approach followed by a transmission of lower energy unfocused wave patterns.

The present invention relates to the use of various therapeutic pressure pulse wave patterns or acoustic shock wave patterns as illustrated in FIGS. 1-3 for treating patients having nerve damage or nerve lesions in the spinal cord region that have degraded the performance of the autonomic nervous system. Each illustrated wave pattern will be discussed later in the description; however, the use of each has particularly interesting beneficial features that are a remarkably valuable new tool in the fight against such diseases.

With reference to FIGS. 1-3, a variety of schematic views of acoustic shock waves or pressure pulses are described. The following description of the proper amplitude and pressure pulse intensities of the shock waves are provided along with a description of how the shock waves actually function. For the purpose of describing, the shock waves were used as exemplary and are intended to include all of the wave patterns discussed in the figures as possible treatment patterns.

FIG. 1 is a simplified depiction of a pressure pulse/shock wave (PP/SW) generator, such as a shock wave head, showing focusing characteristics of transmitted acoustic pressure pulses. Numeral 1 indicates the position of a generalized pressure pulse generator, which generates the pressure pulse and, via a focusing element, focuses it outside the housing to treat diseases. The affected tissue or organ is generally located in or near the focal point which is located in or near position 6. At position 17 a water cushion or any other kind of exit window for the acoustical energy is located.

FIG. 2 is a simplified depiction of a pressure pulse/shock wave generator, such as a shock wave head, with plane wave characteristics. Numeral 1 indicates the position of a pressure pulse generator according to the present invention, which generates a pressure pulse which is leaving the housing at the position 17, which may be a water cushion or any other kind of exit window. Somewhat even (also referred to herein as “disturbed”) wave characteristics can be generated, in case a paraboloid is used as a reflecting element, with a point source (e.g. electrode) that is located in the focal point of the paraboloid. The waves will be transmitted into the patient's body via a coupling media such as, e.g., ultrasound gel or oil and their amplitudes will be attenuated with increasing distance from the exit window 17.

FIG. 3 is a simplified depiction of a pressure pulse shock wave generator (shock wave head) with divergent wave characteristics. The divergent wave fronts may be leaving the exit window 17 at point 11 where the amplitude of the wave front is very high. This point 17 could be regarded as the source point for the pressure pulses. In FIG. 1c the pressure pulse source may be a point source, that is, the pressure pulse may be generated by an electrical discharge of an electrode under water between electrode tips. However, the pressure pulse may also be generated, for example, by an explosion, referred to as a ballistic pressure pulse. The divergent characteristics of the wave front may be a consequence of the mechanical setup.

This apparatus, in certain embodiments, may be adjusted/modified/or the complete shock wave head or part of it may be exchanged so that the desired and/or optimal acoustic profile such as one having wave fronts with focused, planar, nearly plane, convergent or divergent characteristics can be chosen.

A change of the wave front characteristics may, for example, be achieved by changing the distance of the exit acoustic window relative to the reflector, by changing the reflector geometry, by introducing certain lenses or by removing elements such as lenses that modify the waves produced by a pressure pulse/shock wave generating element. Exemplary pressure pulse/shock wave sources that can, for example, be exchanged for each other to allow an apparatus to generate waves having different wave front characteristics are described in detail below.

In one embodiment, mechanical elements that are exchanged to achieve a change in wave front characteristics include the primary pressure pulse generating element, the focusing element, the reflecting element, the housing and the membrane. In another embodiment, the mechanical elements further include a closed fluid volume within the housing in which the pressure pulse is formed and transmitted through the exit window.

In one embodiment, the apparatus of the present invention is used in combinations of shock wave therapies. Here, the characteristics of waves emitted by the apparatus are switched from, for example, focused to divergent or from divergent with lower energy density to divergent with higher energy density. Thus, effects of a pressure pulse treatment can be optimized by using waves having different characteristics and/or energy densities, respectively.

While the above described universal toolbox of the various types of acoustic shock waves or pressure pulses and types of shock wave generating heads provides versatility, the person skilled in the art will appreciate that apparatuses that produce low energy or soft acoustic shock waves or pressure pulses having, for one example, nearly plane characteristics, are less mechanically demanding and fulfill the requirements of many users.

As the person skilled in the art will also appreciate that embodiments shown in the drawings are independent of the generation principle and thus are valid for not only electro-hydraulic shock wave generation but also for, but not limited to, PP/SW generation based on electromagnetic, piezoceramic and ballistic principles. The pressure pulse generators may, in certain embodiments, be equipped with a water cushion that houses water which defines the path of pressure pulse waves that is, through which those waves are transmitted. In a preferred embodiment, a patient is coupled via ultrasound gel or oil to the acoustic exit window (17), which can, for example, be an acoustic transparent membrane, a water cushion, a plastic plate or a metal plate.

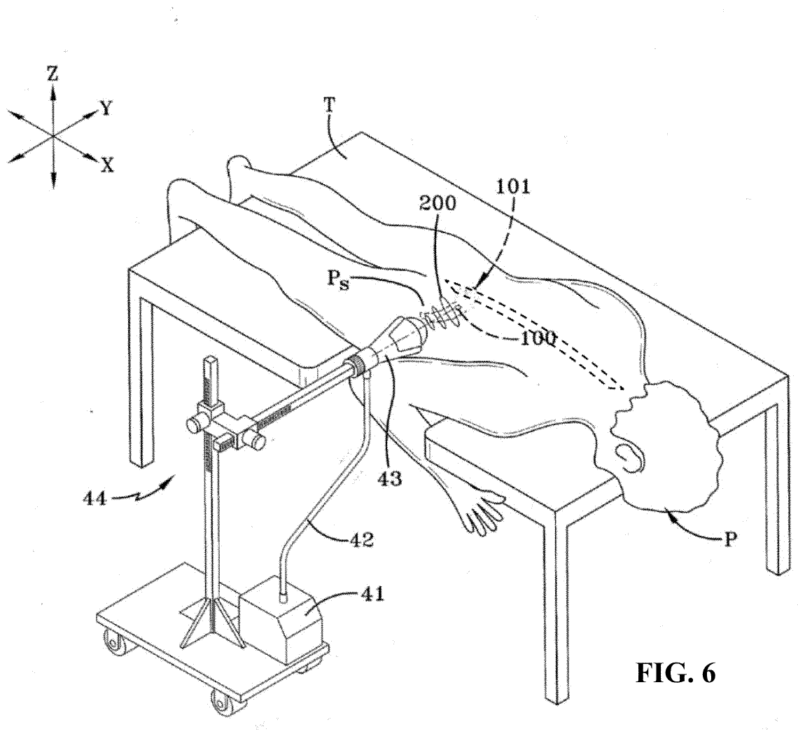

FIG. 5 shows an exemplary shock wave device generator or source 1 with a control and power supply 41 connected to a hand-held applicator shock wave head 43 via a flexible hose 42 with fluid conduits. The illustrated shock wave applicator 43 has a flexible membrane at an end of the applicator 43 which transmits the acoustic waves when coupled to the skin by using a fluid or acoustic gel. As shown, this type of applicator 43 has a hydraulic spark generator using either focused or unfocused shock waves, preferably in a low energy level, less than the range of 0.01 mJ/mm² to 0.3 mJ/mm². The flexible hose 42 is connected to a fluid supply that fills the applicator 43 and expands the flexible membrane when filled. Alternatively, a ballistic, piezoelectric or spherical acoustic shock wave device can be used to generate the desired waves.

With reference to FIG. 6, a perspective view of a portion of the treatment region 200 is shown between the lower brain stem to the lower end of the spinal cord. The neurological tissue 100, more commonly referred to as the medulla oblongata and the spinal cord tissue, is the principal source of neurological connectivity activity between the organs and the limbs. With further reference to FIG. 6, the patient P who has nerve damage or nerve lesions due to a spinal cord injury or stenosis is positioned on a table T preferably face down lying on the stomach. A shock wave applicator head 43 is brought into contact with the skin Ps preferably an acoustic gel is used to enhance the transmission of the shock waves 200 through the body down to the subsurface nerve tissue 100 in the region 101 below the lower brain stem preferably at the lower spine region to the end of the spinal cord. The shock wave applicator head 43 is connected via cabling 42 to a power generating unit 41 as shown. The shock wave applicator head 43 can be attached rigidly to a fixture or stand 44 as illustrated or alternatively can be hand held and manipulated across the skin Ps to drive the shock waves 200 in the direction the shock wave head 43 is pointed to activate a response to the nerve tissue.

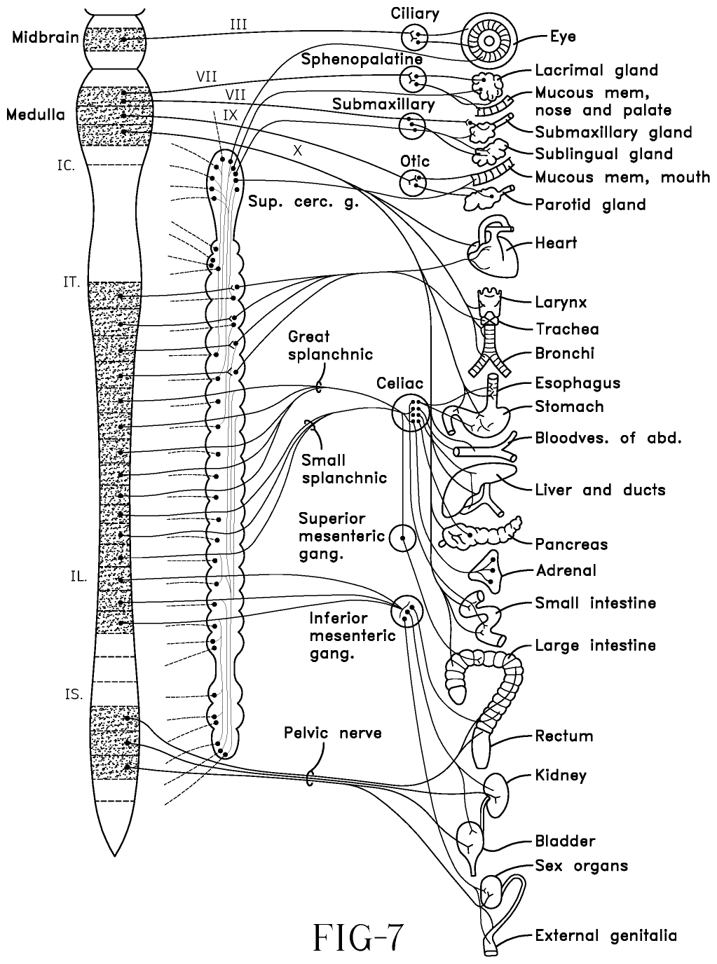

The viscera are mainly innervated parasympathetically by the vagus nerve and sympathetically by the splanchnic nerves. The sensory part of the latter reaches the spinal column at certain spinal segments. Pain in any viscera is perceived as referred pain, more specifically pain from the dermatome corresponding to the spinal segment. To better appreciate the overall connections between the lower brain stem and the nerves of the spinal cord, a diagram from Gray's Anatomy is provided as FIG. 7. This chart shows the various organs, glands and tissues that are connected by the nerves and controlled by the regions of the medulla oblongata to the end of the spinal cord.

Shock waves are a completely different technology and a quantum leap beyond other forms of neurological treatments. The mechanism of shock waves is far from being understood, but is known to cause new blood vessels to grow in an area of treatment and regenerate bony tissue. In the present invention shock waves are used to treat patients with nerve damage or neurological disease by not only regenerating or repairing the neurological tissue or creating new nerve architecture, but most remarkably reactivating a degraded autonomic nervous system response. This is a phenomenal advancement in the current approach which generally avoids difficult surgery or can be used in conjunction with a surgically repaired injury as a complimentary treatment to such surgery. If surgery could be replaced in many cases, it would save millions of dollars, gain wide acceptance (non-invasive) and be a tremendous benefit to patients worldwide.

The present invention employs the use of pressure pulses or shock waves to stimulate a neuron or cellular nerve response stimulating the autonomic system to respond starting a tissue regenerative healing process that activates the tissue or nerve cells not only of damaged nerves, but also initiates a systemic healing process to re-energize affected organs and muscle tissue through an improvement in the degraded autonomic nervous system.

In the pressure pulse or shock wave method of treating a tissue, an organ or the entire body of a human patient with a risk of degenerative neurological or nerve damage or post-occurrence of such damage requires the patient to be positioned in a convenient orientation to permit the source of the emitted waves to most directly send the waves to the target site to initiate pressure pulse or shock wave stimulation of the target area or zone with minimal, preferably with little or no obstructing features in the path of the emitting source or lens. Assuming the treatment region is accessible through an open surgical access region then the shock wave head 43 can be inserted and placed directly on or adjacent to the treatment region 200. Alternatively, the shock wave head 43 can be placed externally on the back and transmit the emitted shock wave patterns through the skin, spinal bone tissue 116 for example and into the adjacent nerve tissue 100 to be treated, as shown in FIG. 6. In the case of extracorporeal non-invasive treatments of damaged nerves, preferably the outer skin tissue is pressed against the treatment region to insure the transmission loss is minimal. In some cases, the treatment zone may benefit or require numbing prior to treatments in advance of surgical procedures. This is particularly true after a number of treatments over a period of time, because as the nerves heal, the patient's sensation of pain will be reacquired. This is particularly true if the use of high energy focused waves are being transmitted through the spinal bone tissue to stimulate the sensitive nerves in the treatment area. Assuming the target area or site is within a projected area of the wave transmission, a single transmission dosage of wave energy may be used. The transmission dosage can be from a few seconds to 20 minutes or more dependent on the condition. Preferably the waves are generated from an unfocused or focused source. The unfocused waves can be divergent, planar or near planar and having a low pressure amplitude and density in the range of 0.00001 mJ/mm² to 1.0 mJ/mm² or less, most typically below 0.2 mJ/mm². The focused source preferably can use a diffusing lens or have a far-sight focus to minimize if not eliminate having the localized focus point within the tissue. Preferably the focused shock waves are used at a similarly effective low energy transmission or alternatively can be at higher energy but wherein the tissue target site is disposed pre-convergence inward of the geometric focal point of the emitted wave transmission. In treating some hard to penetrate regions, the pressure pulse more preferably is a high energy target focused wave pattern which can effectively penetrate through outer structures prior to being dampened while still exposing the nerves or neurons to activating pressure pulses or shock waves. This emitted energy preferably stimulates the cells with minimal rupturing of cellular membranes. The surrounding healthy cells in the region treated are activated initiating a defence mechanism response to assist in eradication of the unwanted infection or diseased tissue while stimulating new growth and enhanced autonomic nervous system performance.

These shock wave energy transmissions are effective in stimulating a cellular response and can be accomplished without creating excessive cavitation bubbles in the tissue of the target site when employed in other than site targeted high energy focused transmissions. This effectively ensures the spinal cord tissue or lower brain tissue does not have to experience the sensation of excessive hemorrhaging so common in the use of higher energy focused wave forms having a focal point at or within the targeted treatment site.

If the target site is the spinal cord subjected to a surgical procedure exposing at least some if not all of the tissue, then the target site may be such that the patient or the generating source must be reoriented relative to the site and a second, third or more treatment dosages can be administered. The fact that some if not all of the dosage can be at a low energy the common problem of localized hemorrhaging can be reduced making it more practical to administer multiple dosages of waves from various orientations to further optimize the treatment and cellular stimulation of the target site. Heretofore focused high energy multiple treatments induced pain and discomfort to the patient. The use of low energy focused or un-focused waves at the target site enables multiple sequential treatments with minimal pain.

The present method may need precise site location and can be used in combination with such known devices as ultrasound, cat-scan or x-ray imaging if needed. The physician's general understanding of the anatomy of the patient may be sufficient to locate the target area to be treated. This is particularly true when the exposed nerve tissue or portion of the trauma to the body or organ is visually within the surgeon's line of sight and this permits the lens or cover of the emitting shock wave source to impinge on the affected organ or tissue directly or through a transmission enhancing gel, water or fluid medium during the pressure pulse or shock wave treatment. The treated area can withstand a far greater number of shock waves based on the selected energy level being emitted. For example at very low energy levels the stimulation exposure can be provided over prolonged periods as much as 20 minutes if so desired. At higher energy levels the treatment duration can be shortened to less than a minute, less than a second if so desired. The limiting factor in the selected treatment dosage is minimization of surrounding cell hemorrhaging and other kinds of damage to the surrounding cells or tissue while still providing a stimulating stem cell activation or a cellular release or activation of proteins such as brain derived neurotropic factor (BDNF) or VEGF and other growth factors while simultaneously germicidally attacking the degenerative tissue or infectious bacteria at the wound site.

Due to the wide range of beneficial treatments available it is believed preferable that the optimal use of one or more wave generators or sources should be selected on the basis of the specific application. Wherein relatively small target sites may involve a single wave generator placed on an adjustable manipulator arm. A key advantage of the present inventive methodology is that it is complimentary to conventional medical procedures. In the case of any operative surgical procedure the surgical area of the patient can be bombarded with these energy waves to stimulate cellular release of healing agents and growth factors. This will dramatically reduce the healing process time. Most preferably such patients may be provided more than one such treatment with an intervening dwell time for cellular relaxation prior to secondary and tertiary post-operative treatments.

The underlying principle of these pressure pulse or shock wave therapy methods is to enrich the treatment area directly and to stimulate the body's own natural healing capability by causing the degraded autonomic nervous system to activate a response. This is accomplished by deploying shock waves to stimulate strong cells in the surrounding tissue to activate a variety of responses. The acoustic shock waves transmit or trigger what appears to be a cellular communication throughout the entire anatomical structure, this activates a generalized cellular response at the treatment site, in particular, but more interestingly a systemic response in areas more removed from the wave form pattern. This is believed to be one of the reasons molecular stimulation can be conducted at threshold energies heretofore believed to be well below those commonly accepted as required. Accordingly, not only can the energy intensity be reduced in some cases, but also the number of applied shock wave impulses can be lowered from several thousand to as few as one or more pulses and still yield a beneficial stimulating response. The key is to provide at least a sufficient amount of energy to activate healing reactions.

Even more striking as mentioned earlier, early prevention therapies can be employed to stimulate tissue or organ modelling to be maintained within acceptable ranges prior to an exposure to a degenerative failure. This is extremely valuable in the prevention of spreading the infection or degenerative condition for example. The methods would be to identify at risk patients with a known exposure risk and subjecting that patient to therapeutic shock wave therapy for the purpose of stimulating neurological tissue repair or regeneration effectively remodelling the patient's susceptible organs to be within accepted functional parameters prior to irreparable degeneration. The objective being to preventively stimulate cellular tissue repairs to pre-emptively avoid a degenerative condition from occurring which may result in the onset of a degenerative condition which can require invasive surgical procedures.

As shown in FIGS. 1-3 the use of these various acoustic shock wave forms can be used separately or in combination to achieve the desired therapeutic effect in treating patients with nerve damage, most importantly to trigger an autonomic nervous system response in a degraded autonomic nervous system caused by a stenosis or spinal injury or lesion.

Furthermore, such acoustic shock wave forms can be used in combination with drugs, chemical treatments, irradiation therapy or even physical therapy and when so combined the stimulated cells will more rapidly assist the body's natural healing response and thus overcomes the otherwise potentially tissue damaging effects of these complimentary procedures.

The present invention provides an apparatus for an effective treatment of indications, which benefit from high or low energy pressure pulse/shock waves having focused or unfocused, nearly plane, convergent or even divergent characteristics. With an unfocused wave having nearly plane, plane, convergent wave characteristic or even divergent wave characteristics, the energy density of the wave may be or may be adjusted to be so low that side effects including pain are very minor or even do not exist at all.

One of the keys to the present invention is not just pain, but reducing inflammation, or hyper arousal inflammation for PGAD. This Persistent Gonad Arousal Disorder affects women who have suffered for years. The present method specifically cures PGAD, Persistent Gonad Arousal Disorder. This method has had miraculous results on women who have suffered for years. These women have 50 orgasms per day just via daily activity. They cannot exercise. The present method also cures premature ejaculation by using this lower spine treatment helping many of these patients.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of treating a patient exhibiting abdominal or pelvic pain by applying shockwaves or acoustic pulses to the lower spine, lumbar and sacral spine, to modulate, reduce or relieve spinal stenosis, inflammation, injury or disease and comprises the steps of:
activating an acoustic shock wave or acoustic wave generator or source to emit acoustic shock waves or pulses from a fixed acoustic wave source or a handheld shock wave head or from electrodes embedded within a catheter with or without a fluid filled balloon catheter; and
administering a plurality of acoustic shock or acoustic waves in a pulse or wave pattern within the targeted tissue of less than 10.0 mJ/mm² per shock wave, the plurality of acoustic shock or acoustic waves in a pulse or wave pattern should be directed to a portion of a lower spine exhibiting chronic pain and/or inflammation.

2. The method of claim 1 wherein the chronic pain and inflammation radiates from the lower spine region to other organs or connective tissue causing acute or chronic pain in the organs or connective tissue of the abdomen, pelvis, or genitalia.

3. The method of claim 1 wherein the step of administering a plurality of acoustic or shock waves to the lower spine reduces chronic pain and inflammation radiating at the lower spine and further reduces chronic pain including orchialgia, prostatitis, bladder pain, interstitial cystitis or digestive tract pain.

4. The method of claim 1 wherein the chronic pain and inflammation at the lower spine region radiates causing ghost or referred pain defined as non-specific pain at other organs or connective tissue and/or parts of the body and wherein the method further comprises the step of reducing ghost pain by administering the plurality of acoustic shock waves to the lower spine and locations at or near the areas exhibiting the ghost pain.

5. The method of claim 1 wherein the treatment is directed to treat women experiencing PGAD.

6. The method of claim 1 wherein the treatment is directed to treat patients having premature ejaculations.
